(19) United States
(12) Patent Application Publication
(10) Pub. No.: US 2009/0224527 A1
(43) Pub. Date: Sep. 10, 2009

(54) Contextual thinking tool and presentation device

(76) Inventor: Ruven Washor Liebhaber, Lexington, MA (US)

Correspondence Address: ANTOINETTE G. GIUGLIANO, P.C.;DBA AGG Intellectual Property Law, 100 Cummings Center, Suite 213C, Beverly, MA, 01915, US

(21) Appl. No.: 11/522,202

(22) Filed: Sep. 15, 2006

Related U.S. Application Data
(60) Provisional application No. 11/374,289, filed on Sep. 16, 2005.

(51) Int. Cl. B42D 15/00

(52) U.S. Cl. 283/62

(57) ABSTRACT

Foldable mechanical device aids contextual thinking, planning, problem solving and image viewing by allowing the selection of variables displayed around a central subject on tabs that are deployable over the central subject.

### BACKGROUND

Tools currently available for facilitating analytical thinking and planning are in either planar printed (e.g. book) or electronic format. Book formats typically require the user to turn from page to page to access more than two pages of information at a time. This makes it difficult for the user to conceptualize multiple aspects or images in one view. Electronic formats typically require the user to view a screen (e.g. computer). The information appears on a two-dimensional display and is not visible when the device is turned off.

### OBJECTS AND ADVANTAGES

The present invention provides a tool that can facilitate contextual thinking, planning, and presentation of images in a wide variety of applications.

The Contextual Thinking Tool And Presentation Device of the invention (here-in-after referred to as the “Contextual Tool”) provides method and apparatus directed to conceptualizing and solving problems as well as presenting information and images, and which facilitates development of a holistic view. Embodiments of the invention encourage and support brainstorming and contextual (big-picture thinking), both by individuals and in interaction with others (e.g. in a business meeting). Such embodiments are also intended to engage the user(s) in multiple modalities—intellectual, visual, verbal, spatial, and tactile.

In contrast to a planar printed or electronic representation, preferred embodiments of the Contextual Tool include a three dimensional physical object. In one embodiment, the Contextual Tool is folded into a smaller object which features a selected shape, can be transported easily, and is non-electronic. Other objectives and advantages will become apparent from the following specification and drawings.

### BRIEF DESCRIPTION OF THE DRAWINGS

A further understanding of the various illustrative embodiments of the present invention may be realized by reference to the figures which are described in remaining portions of the specification. In the figures, like reference numerals are used throughout several to refer to similar components.

FIG. 1 shows in plan view a pentagonal embodiment of the invention,

FIG. 2 shows a triangular embodiment of the invention,

FIG. 3 shows a square embodiment of the invention,

FIG. 4 shows a hexagonal embodiment of the invention,

FIG. 5 shows an embodiment of the invention with a variety of flap configurations,

FIG. 6A shows an embodiment of the invention with tabs,

FIG. 6B shows a top view of the embodiment of FIG. 6A,

FIG. 6C shows in schematic cross-sectional view (not to scale), taken along line 6C-6C of FIG. 6B,

FIG. 7A shows in plan view an embodiment of the invention with depth,

FIG. 7B shows a schematic cross-sectional view (not to scale), taken along line 7B-7B of FIG. 7A,

FIG. 8 shows an embodiment of the invention with mitered corners,

FIG. 9 shows an embodiment of the invention with mitered corners and depth,

FIG. 10A,B shows a hospice “Circle of Caring Planner” embodiment of the invention,

FIG. 11A,B shows a “PentaView Project Decision-making Facilitator” embodiment of the invention,

FIG. 12A,B shows a “School Minder” embodiment of the invention,

FIG. 13A,B shows a “Photo Montage” embodiment of the invention, and

FIG. 14A,B shows a “Life Balance” embodiment of the invention.

### SUMMARY OF THE INVENTION

The present invention provides a foldable mechanical device for use in contextual thinking, planning, problem solving and/or image viewing by enabling selection of variables displayed around a central or pivotal subject matter. In one illustrative embodiment, the invention features a three-dimensional communication tool having a predetermined stowage configuration, a physical object with a plurality of predefined articulation parts (e.g., folds, joints or hinges or the like), and a predefined shaped periphery. The physical object includes several areas, also referred to as sections, including a central (or center) content section and supporting content sections.

The articulation parts are at the periphery of the central section and the surrounding supporting sections have proximal portions associated with the central section via the articulation parts. The supporting sections also have distal portions which cooperate to define the predefined shaped periphery. The supporting sections define flaps which are foldable at the articulation parts toward the central section. The flaps are deployed over at least a portion of the central section when the object is in the predetermined stowage configuration, wherein the proximal portions define the periphery of the predetermined stowage configuration. Preferably the central section acts as central content section and the supporting sections act as supporting content sections.

Practice of the illustrative embodiment may include: wherein the physical object has a first side and a second side; wherein the sides are separated into the sections; wherein each section is capable of displaying content for communicating elements of a common theme; wherein the content includes fixed content and user-content; wherein the user-content may be user-generated, user-applied or user-selected; and wherein the device functions according to the user content in cooperation with a theme guided by the fixed content. Various embodiments of the invention include a device enabling contextual thinking, project planning and concept presentation.

Such practice may also include: wherein the predetermined shape is polygonal; wherein the theme is a “Circle of Caring Planner” for organization and planning of activities related to hospice issues; wherein the theme is a project decision-making facilitator for organization and planning of activities related to a project; wherein the theme is a school-minder for organization and planning of activities related to school; wherein the theme is organization and planning of activities related to life balance; and wherein the tool operates without electrical power; and wherein the fixed content includes images.

In another illustrative embodiment of the invention, a Contextual Tool features a three dimensional physical object having predefined fold lines, the object being foldable into a smaller object having a predetermined shape, the physical object having a plurality of predefined folding flaps located along the fold lines and having a predefined shaped periphery, the object including a central content section and supporting content sections, the fold lines being at the periphery of the central section, the supporting sections having proximal portions associated with the central section via the fold lines, the supporting sections having distal portions, the distal portions cooperating to define the predefined shaped periphery, the surrounding sections defining flaps, the flaps being foldable at the fold lines toward the central section, and the flaps being deployed over at least a portion of the central section when the object is in the predetermined shape.

Practice of such illustrative embodiment may include: wherein the tool is a foldable mechanical device that aids contextual thinking, planning, problem solving and image viewing by allowing the selection of variables displayed around a central content; wherein the central section has N edges wherein N is greater than 2 and further having a flap that extends from at least two edges, the flaps being of any selected shape, and wherein each flap is not larger than the central section; further having a plurality of the flaps and wherein the flaps are offset from the central section and form tabs when folded toward the center; further having a plurality of the flaps and wherein the flaps are offset from the central section and define a space for insertion of an item of interest; and wherein the tool operates without electrical power.

### Description of Illustrative and Preferred Embodiments

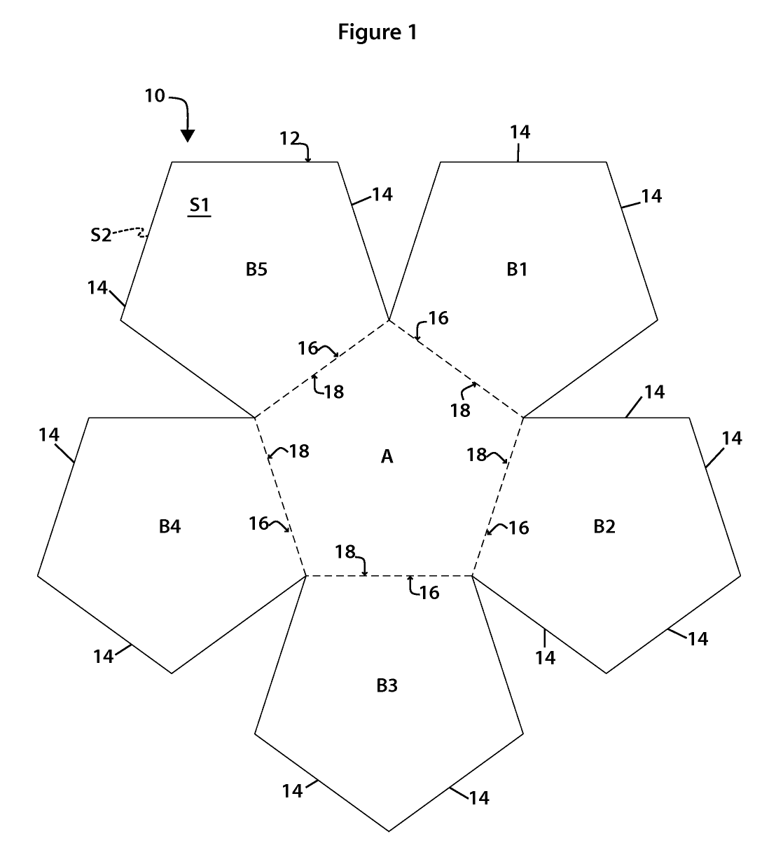

A preferred Contextual Tool device 10 of the invention is shown in FIG. 1 formed using a structural member 12 having a central section A and abutting peripheral sections or flaps B (shown as flaps B1-B5). This structure may be formed using cardstock or the like, and results in a two-sided (sides S1, S2) complex-shaped object having multiple edges 14. In this illustrative embodiment, the multi-edged configuration is based on a pentagonal theme wherein central section A is pentagonal and has pentagonal flaps B1-B5 attached thereto. Each flap B is attached at one of the edges 16 (dotted line) of pentagonal central section A and preferably is slightly smaller in area than pentagonal central section A.

An illustrative embodiment of device 10 is formed as follows: starting with a large piece of cardstock 12; forming the geometric shapes such as shown in FIG. 1 by cutting along the solid lines that form the outer edges 14; scoring fold lines 18 along edges (dotted lines) 16, and folding the cardstock along these fold lines. These fold lines (acting as hinges or joints) enable the flaps to be folded over toward the central portion, and are sometimes also referred to as articulation joints 16. The flaps are foldable over pentagonal central section A in either direction, and in any order.

With all flaps B folded over toward and onto central section A, device 10 has an overall outline dictated by the central section A, which in this embodiment is pentagonal. The folded thickness of the pentagonal device generally reflects six times the thickness of unfolded structural member 12. The flaps and central section A are formed of a single structural member 12 in this embodiment, wherein their inter-connection is indicated by the dotted lines.

Sides S1, S2 have various uses. Side S1 preferably has pre-printed information and can be laminated with a clear film for protection from moisture and grime. Side S2 can also contain pre-printed information and have a writeable surface.

The Contextual Tool is constructed of a material that can hold a shape, and is preferably planar. Such materials include, but are not limited to, paper, cardboard, wood, fabric, plastic, or metal. Regardless of the material used, the flaps preferably are configured to be fold inwardly toward the central section. For example, scoring of the material at the junction between the flaps and the center enables articulation of the flaps. Laminated paper would be scored in this manner. For other materials, such as wood or metal, actual hinges at these places may be required for this articulation purpose.

Thus hinges or joints, whether scored or otherwise formed, enable the flaps to be folded over toward the central section. Each flap preferably can fold independently so that all configurations of flaps folded in either direction or remaining unfolded are possible.

Either or both surfaces of the device may be writeable and/or pre-printed. For example, if the device is made of paper, pencils or erasable pens can be used to make non-permanent notations on the device. If any surface of the device is laminated, special markers can be used to write on that surface. For another embodiment of the invention, disposable notepads can be attached to one or more of the flaps and/or the central section.

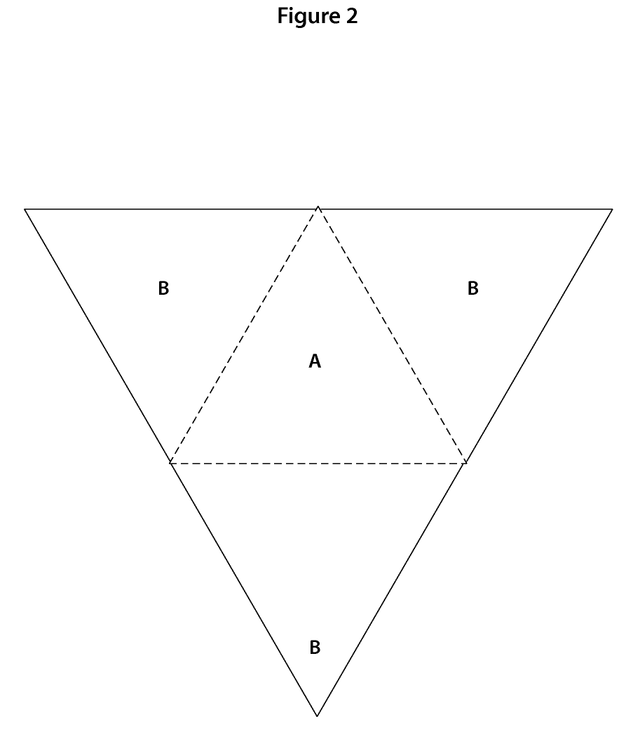

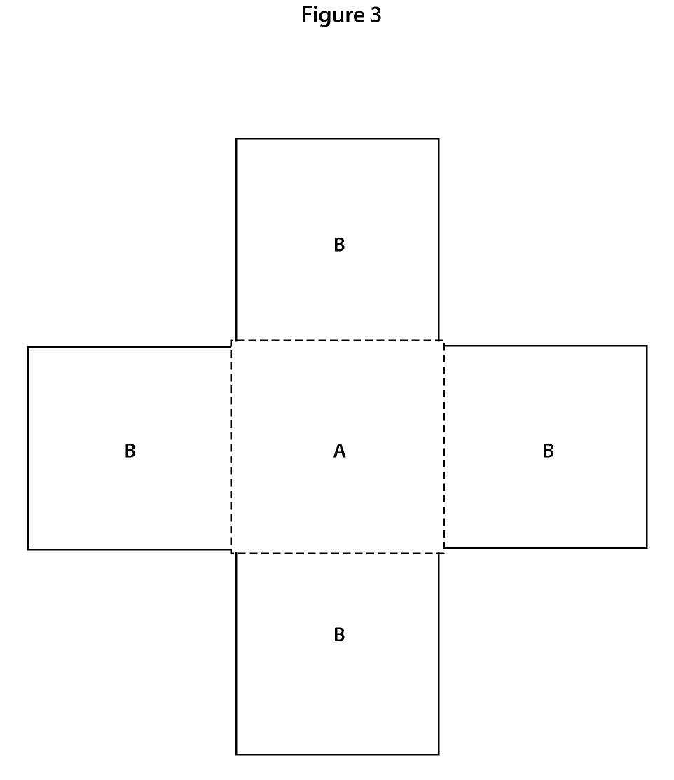

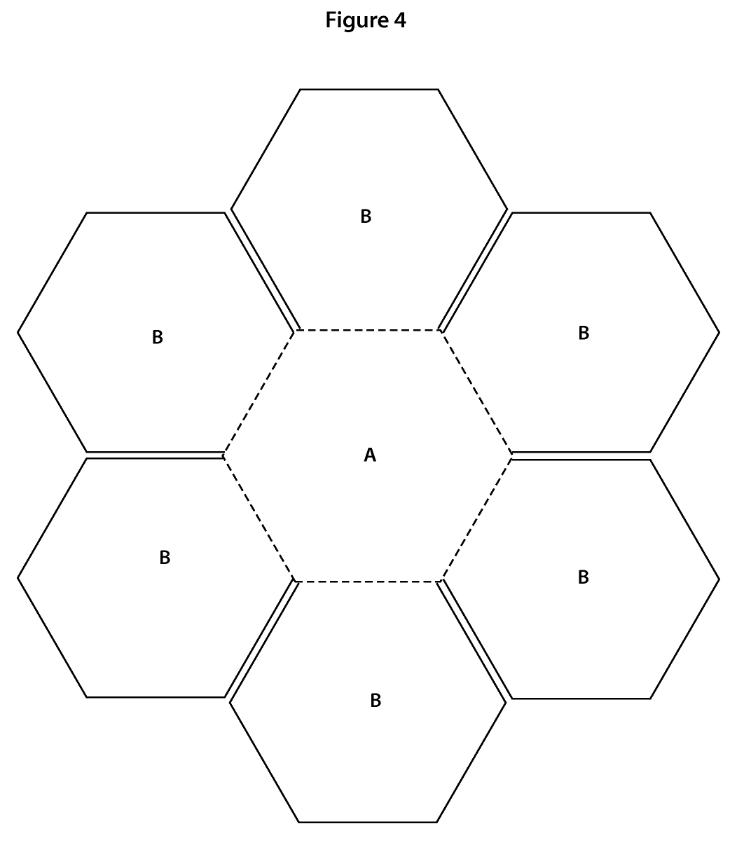

FIGS. 2-5 show additional illustrative embodiments of the invention, including triangular, square, and hexagonal, as well as having a variety of flap configurations, respectively,

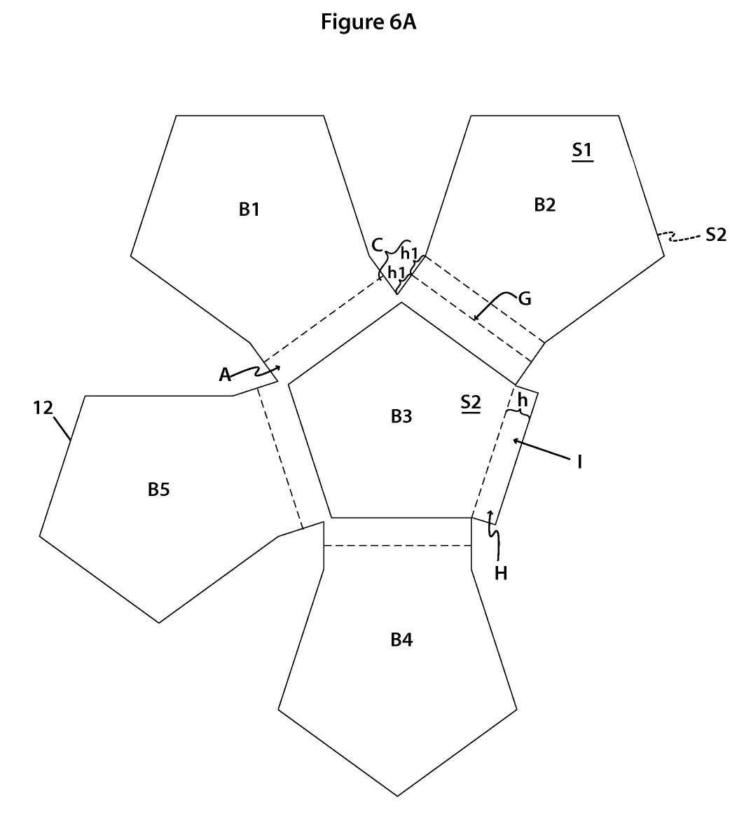

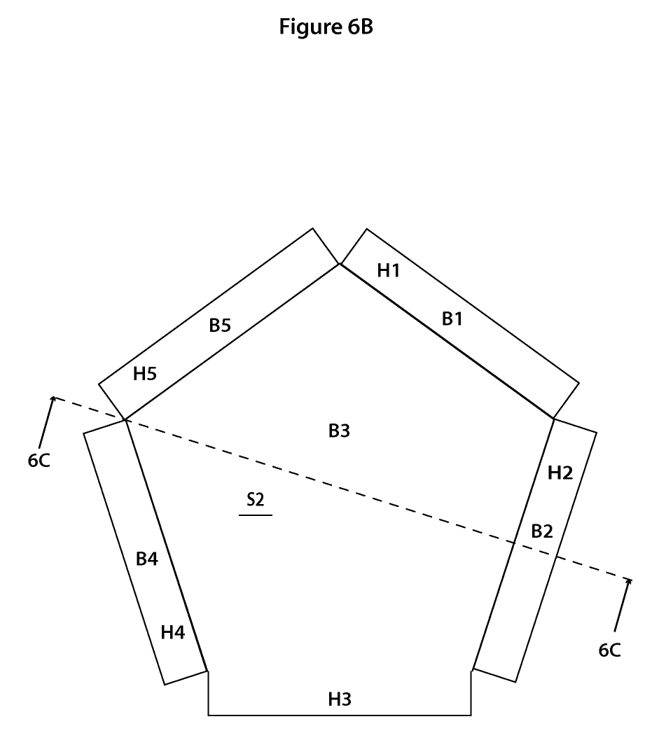

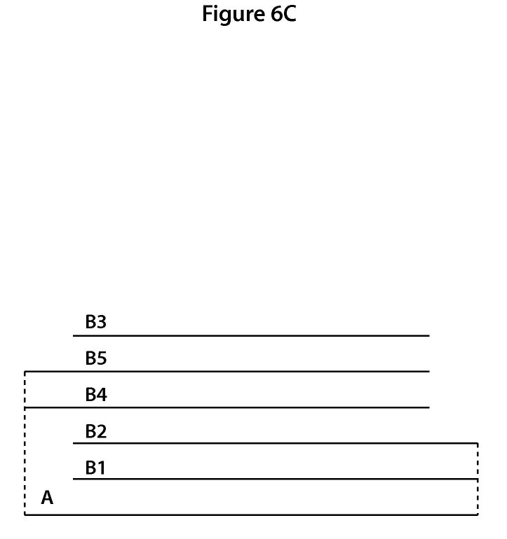

An embodiment of the invention with useful tabs is shown in FIG. 6A,B,C. Flaps B are offset from central section A by an offset C. Referring to FIG. 6C, offset C is formed by a combination of a first length h1 and a second length h1 of structural member 12 which together extend between the center section A and the respective flap B a total length of twice h1. The first and second lengths h1 are formed on either side of and are separated by an articulation joint G (formed along dotted line). When a Flap B is folded over center section A, it is folded at articulation joint G, and forms a tab H of height h1. Tabs H present a surface I on which to provide information such as a title or label for each of flaps (according to subject matter of the embodiment).

Flaps B1-B5 are shown in FIG. 6A, with flap B3 folded over central section A and revealing side S2 of structural member 12. The five flaps are folded over the central section in either direction and in any order and form a pentagonally configured device.

In FIG. 6B, Flap B3 is shown folded over all other previously folded flaps B1, B2, B4, and B5, all of which are folded over central section A (not seen). In this embodiment, the flaps are offset by tab H. Thus the folded flaps do not fully obscure the other flaps. For example, referring to FIG. 6B, folded flap B3 reveals tabs H1, H2, H4, and H5 of flaps B1, B2, B4, and B5, respectively. FIG. 6C shows a side cross-section of the device of FIG. 6A, 6B in its folded condition.

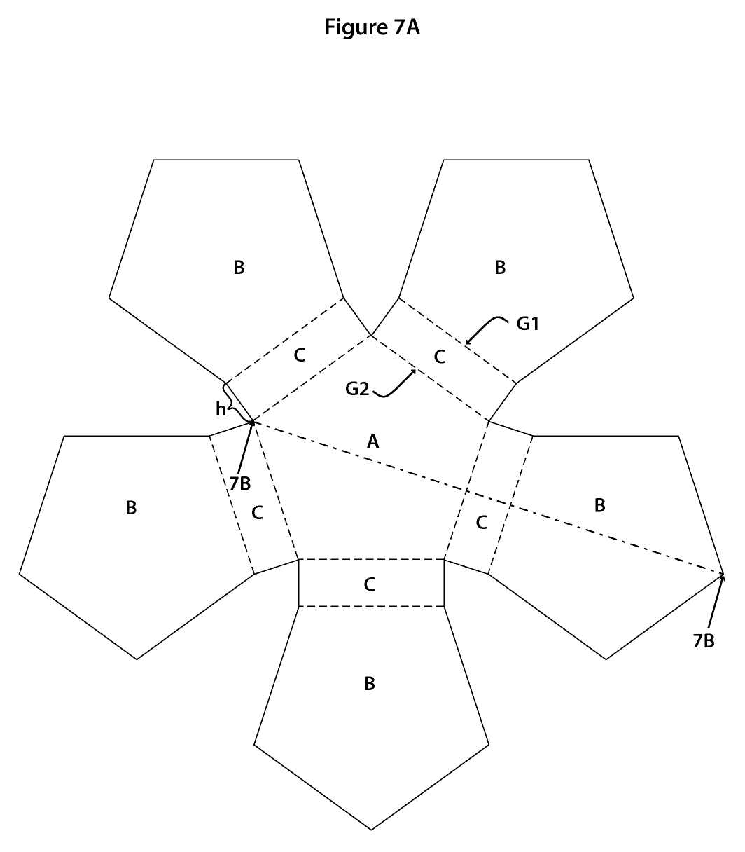

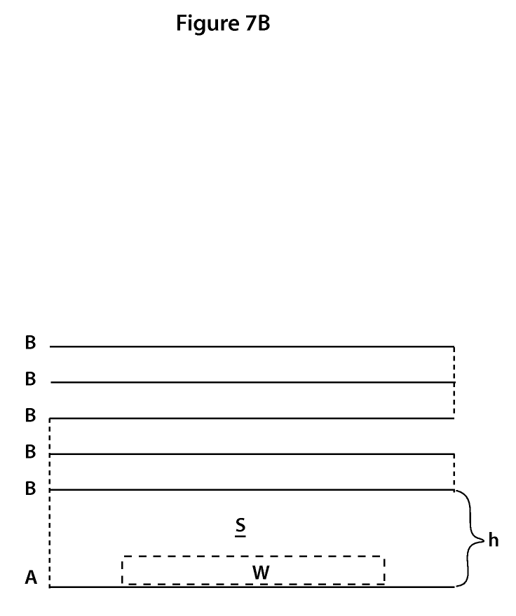

In another embodiment of the invention, as shown in FIG. 7A,B, flaps B are offset from central section A, by offset C of a height h. Flaps B are folded along articulation joints G1, G2, (dotted lines) on both sides of offset C with the result that the flaps are spaced from the center section by a distance h established by offset C. When the flaps are folded over the central section A, there is a space generated having a height h between the lowermost one of the folded flaps and central section A. This height h provides a space S is suitable for attachment of a writing pad W (or business card, pen or the like), shown in dotted outline, and possibly with magnets (not shown) that can be used to attach the device to a metal surface. FIG. 7B shows a side cross-section of the device of FIG. 7A in its folded condition.

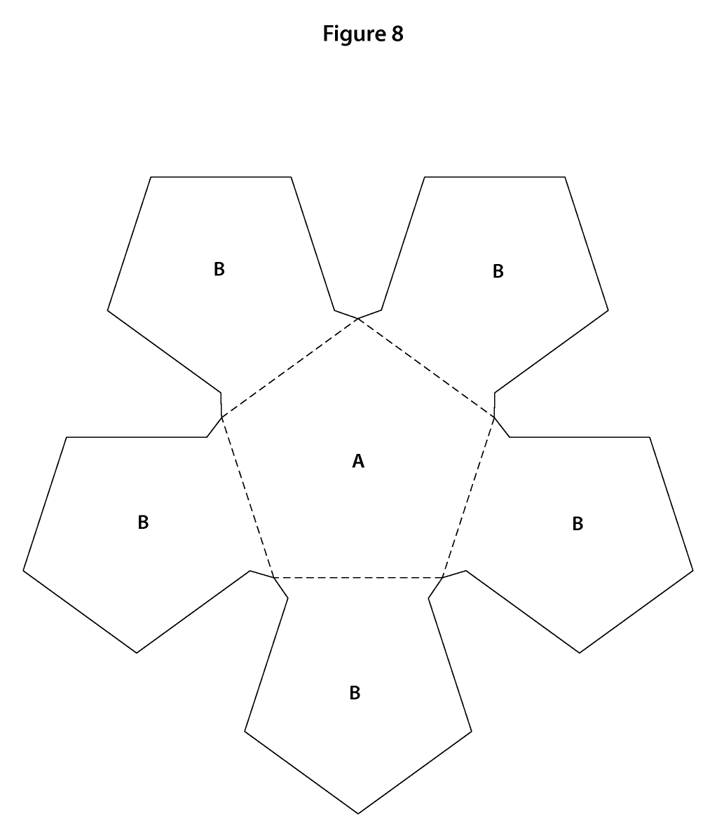

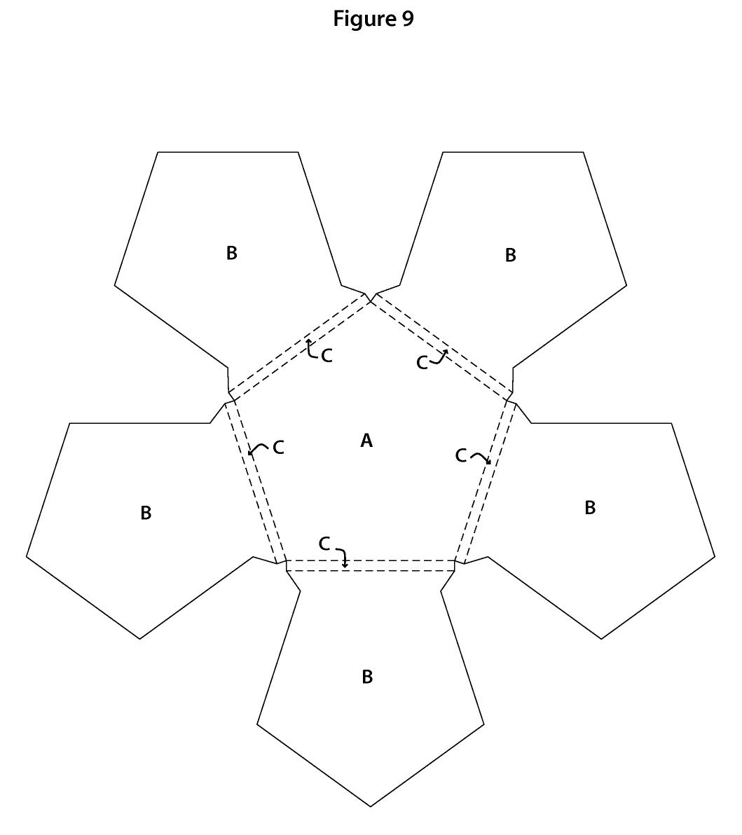

Embodiments depicting further variations on the folding include mitered corners of FIG. 8 and mitered corners with depth as achieved by incorporation of earlier described offsets C (not to scale) as shown in FIG. 9.

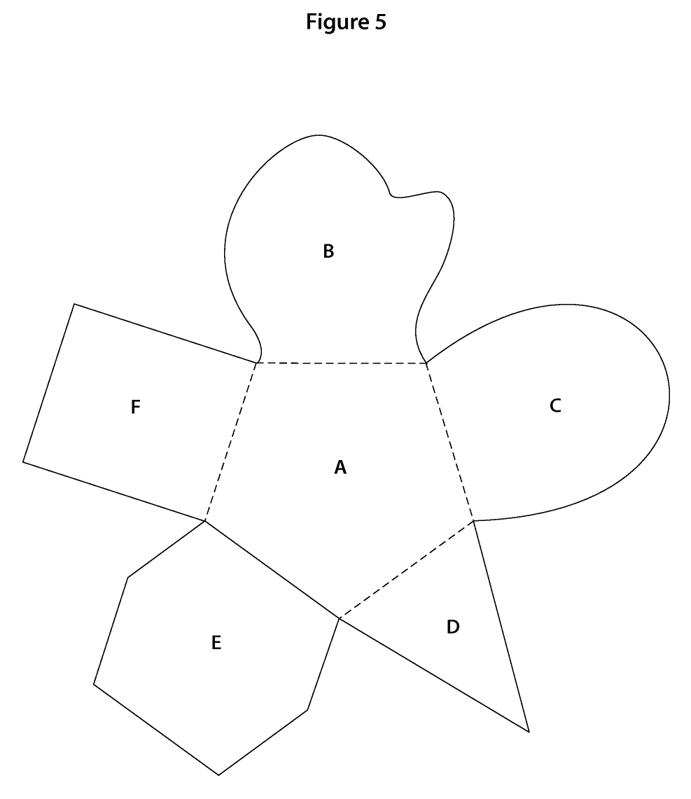

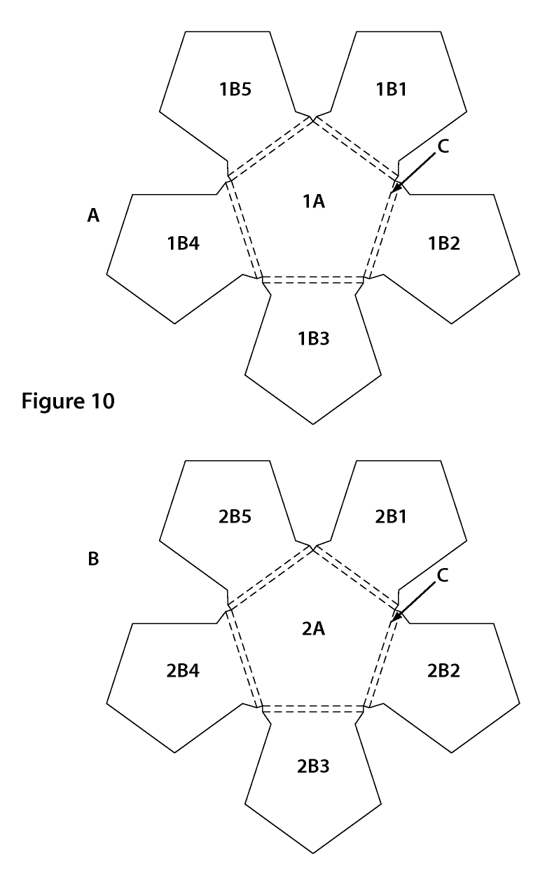

Additional variations are illustrated in FIGS. 10, 11, 12, 13 and 14. These variations have in common a central section A with foldable flaps extending out from its edges. This central area has N edges with N varying, for example, from 3 to 6. A flap can extend from two or more of the edges of the central area. These flaps can be any shape, including, but not limited to, circles, triangles, squares, pentagons, and hexagons, as illustrated in FIG. 5. Each such flap preferably is the same size as or is smaller than central section A, but one flap may be greater in size and be folded as the last fold over the top of the folded members.

The size of the device may be small enough to fit in one's pocket when folded. Larger sizes are possible such as: hole-punched to fit in a 3-ring binder; poster size that can lay flat on a conference table, with writing pads affixed to each of the flaps; mural size to be attached to a wall. The device image can animated or otherwise adapted for a computer screen or projection.

Embodiments of the Contextual Tool device of the invention can provide a structured way of putting issues in their holistic context and displaying related images. There are many applications for the device. Embodiments of the invention may have various numbers of sides. And even for a selected number of sides, potential uses of the blank form are many and varied. What follows are five examples of how five-sided embodiments of the invention can be used, which examples are provided by way of illustration and not limitation.

### EXAMPLES

### Example 1

### Hospice “Circle of Caring Planner” Application of the Contextual Thinking Tool and Presentation Device

As illustrated in FIG. 10A,B, in this example the invention can be used to plan and support the care of hospice patients, and for marketing the services of a hospice organization.

The management of a hospice home care service is responsible for providing quality care to terminally ill patients and to communicate the availability of this care to the marketplace. The Contextual Tool, in this example referred to as the “Circle of Caring Planner”, can provide a structured way of conceptualizing the needs of the hospice patient in a stimulating, easy to understand format. In this embodiment there are five pentagonal flaps around a pentagonal center.

In one embodiment, the device is made of cardstock laminated and preprinted with marketing information on the center section 1A of Side One (FIG. 10A) and is surrounded by visual images of the five dimensions of whole person care (flaps 1B1-1B5). Side Two (FIG. 10B) has optional pre-printed information and is used for customization by writing on the surface with a pencil or an erasable pen, which may be applied to flaps 2B1-2B5 surrounding the content of center section 2A.

The needs of a hospice patient can fall into five distinct areas:
1. Body—Physical comfort
2. Mind—Emotional support
3. Environment—Care environment
4. Resources—Social and Financial resources
5. Spirit—Spiritual needs

Each of the five flaps of the pentagonal device therefore can display information relating to one of these areas of patient need. The hospice management can use the device to explain the hospice concept and service offerings, as well as to plan for the needs of the patient in each of these areas. The device can provide a context for caring for the patient and stimulate brainstorming and thinking about how best to serve the patient in each of these areas. The device can be used as a marketing brochure, displaying information about how the hospice provides services that meet the needs of its patients in each of the five areas. Finally, the device can be used by the patients themselves to help them have important contact information readily accessible, and to be able to successfully manage obtaining of the services that they need in each of these areas.

When the device is open to Side One, the full context of caring for a hospice patient is made apparent through visual images and/or text. The device also engages the user in multiple modalities—intellectual, visual, spatial, and tactile. The device can be kept at a bedside table or posted on a refrigerator. When the device is closed with all flaps folding into the center, it is small enough to transport in one's pocket or purse.

### Example 2

### “PentaView Project Decision-Making Facilitator” Application of the Contextual Thinking Tool and Presentation Device

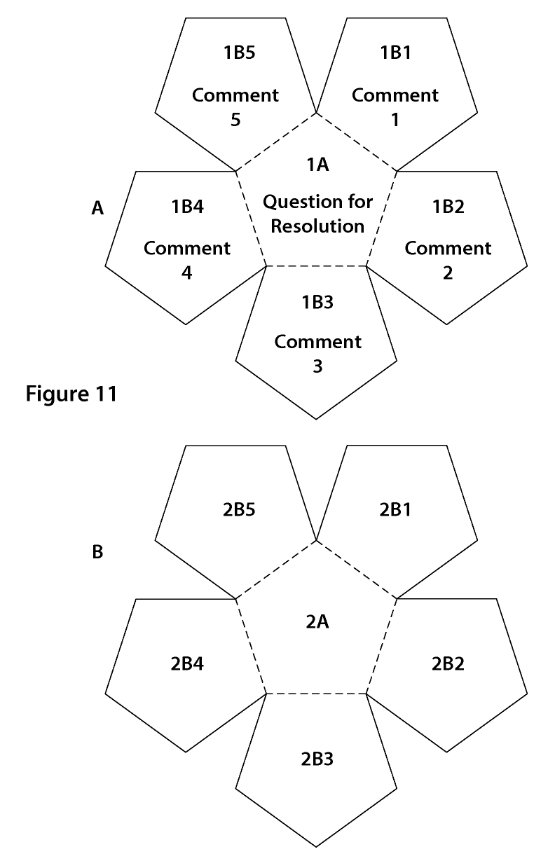

As illustrated in FIG. 11A,B, the invention can be used to facilitate brainstorming during the planning of a facility project. For example, there can be five aspects in planning a facility:

1. Stating the purpose

2. Identifying resources

3. Developing a design and operations plan

4. Implementing the design and operations plan

5. Operating the facility

A five-flap version of the device can be used to conceptualize facility planning issues. Side One is shown in FIG. 11A, wherein the center section 1A on Side One can be used to record a project issue needing deliberation; the flaps on Side One are designated as flaps 1B1-1B5 and can be devoted to a respective one of aspects 1-5 listed above. The users, e.g., the project planners, can write down the basic considerations for each aspect on the corresponding flap.

In one illustration, both sides are used. For example, a question about what type of countertop to choose for a commercial kitchen in a hospital is to be resolved. The question (“Ouestion”, e.g., what kind of sink to purchase) is written on the center panel 1A as shown, Side One. The material options are examined from each of the five vantage points (aspects 1-5) listed on the respective flaps 1B1—1B5 and comments are recorded on these respective flaps as desired.

In FIG. 11A, these comments are associated with respective flaps on Side One, and are indicated as flap 1B1 through 1B5 and comments are indicated as “Comment 1” through 5, respectively. In use, the planning group (architect, owner, contractor) discuss and record: 1) the purpose of the kitchen as a building program element (flap 1B1; Comment 1); 2) the expense and timing implications for material options (flap 1B2; Comment 2); the design impact of the material options, such as thickness, durability and aesthetics (flap 1B3; Comment 3); construction implications, such as availability of the material and tradesmen to install it (flap 1B4; Comment 4); and the long term operations requirements, such as ease of maintenance and sanitation (flap 1B5; Comment 5).

Once the options have been thoroughly discussed, a resolution (e.g., stainless steel) is arrived at and recorded in center 1A, as shown. If further research or follow-up is required, specific assignments for members of the project team can also be recorded on flaps 1B1-1B5.

Side Two (FIG. 11B) can be used to display the name of the project in the center 2A and have project team contact information or associated visual images on flaps (2B1-2B5), for example.

The resulting device can become an elegant and efficient summary of the considerations for making the project successful and can be a powerful communications tool for helping the entire planning team (technical or lay) keep the “big picture” in mind, as well as the details.

### Example 3

### “School Minder” Application of the Contextual Thinking Tool and Presentation Device

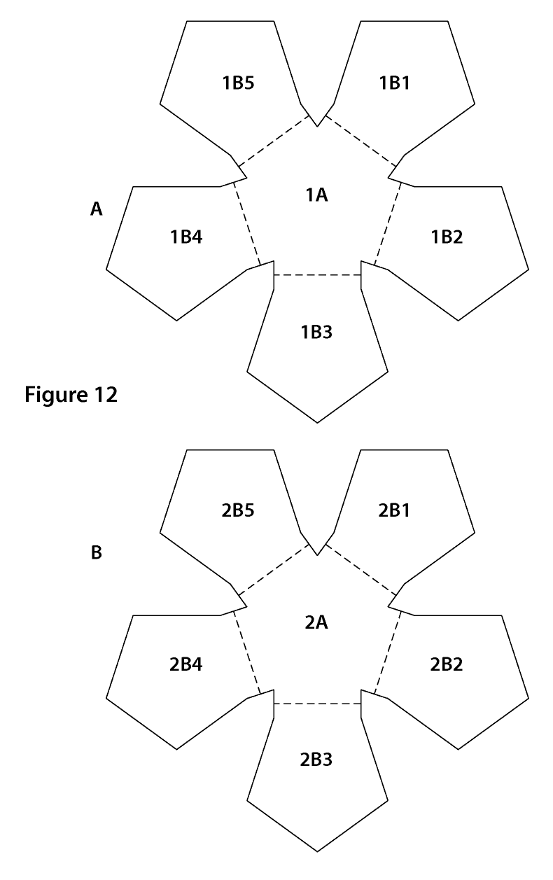

In this example, the invention can be used to assist students in keeping track of their daily school schedule and assignments. The device can have the student's name and identification card in the center 1A of Side One, FIG. 12A, and each of the five weekdays on the flaps (1B1-1B5) with the corresponding class schedule. (Note that if the school is on a six day revolving schedule, the hexagonal version of the invention can be used.) On side two, FIG. 12B, the center 2A can contain a note pad for reminder notes and homework assignments; individual subjects can be recorded on each of the flaps (2B1-2B5). Much of the information on the device can be preprinted by the school, customized for each student and distributed at the beginning of a semester, as a means of helping the students organized.

### Example 4

### “Photo Montage” Application of the Contextual Thinking Tool and Presentation Device

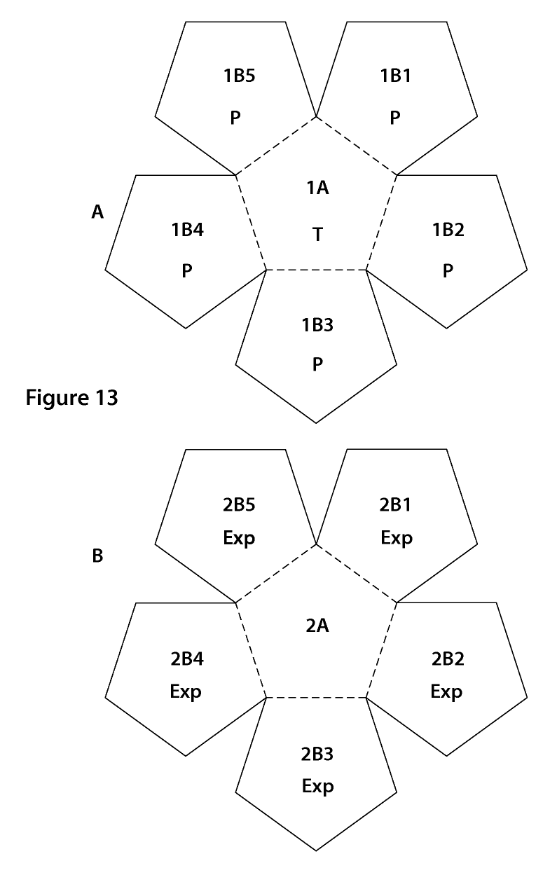

In this example, the invention can be used to display personal photographs. The center 1A of Side One, FIG. 13A, can have the title T of the subject matter displayed, with photo images P displayed on the flaps (1B1-1B5) with or without a caption. Side Two, FIG. 13B, can be used in the same manner as Side One, or used to record captions or written explanations Exp (on flaps 2B1-2B5) of the corresponding images on Side One. The images and written information can be commercially printed, or produced by an individual with use of accompanying computer software.

### Example 5

### “Life Balance” Application of the Contextual Thinking Tool and Presentation Device

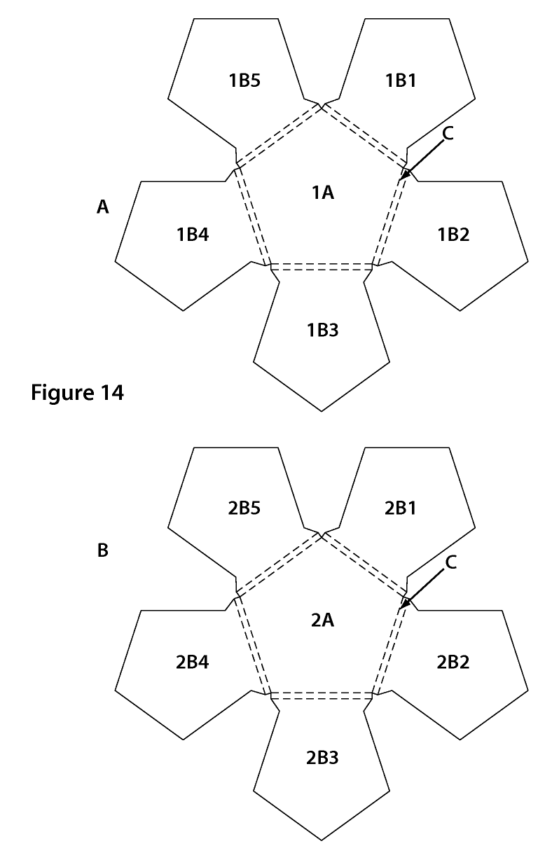

In this example, the invention can be used to aide individuals in keeping use of their time aligned with their personal values. Side One, FIG. 14A, can have various interests recorded on each of the flaps (1B1-1B5) as reminders of what is important for the individual to stay aware of when starting each day or weighing a decision. The center 1A can contain a personal intention, visual image, or note pad. Side Two, FIG. 14B, can be used similarly as Side One, or be used to display visual images on the flaps (2B1-2B5) corresponding to the interests noted on the corresponding reverse side. The device can be preprinted, or partially printed/completely blank for customized use.

### Other Applications

Other uses of the device include, but are not limited to:

Financial Planning—Each flap can cover an aspect of financial planning (e.g. retirement, insurance, budgeted expenses, estate directives and investments). The device can stimulate contextual thinking about one's financial needs and assist in preparing for discussions with a financial planner or spouse.

Choosing a College—A parent and their college-bound child can enter into discussion about college selection by choosing parameters from a list (e.g. campus life, courses of study, expense, geographical location). One parameter is written on each flap, and as with Operation Example 2: “PentaView Project Decision-making Facilitator”, a methodical process of analysis and deliberation can ensue for each institution being considered.

Other Personal/Life Decisions—This is similar to Example 5: “Life Balance” Application of the Contextual Thinking Tool And Presentation Device, however the subject matter can be buying a home, making a career choice, going on vacation.

Product Marketing—In these applications, manufacturing companies can offer consumers a means of determining the right product for them, and a comparison to their competitors. Factors and images can be displayed on the flaps; company identification and a place for recording a decision can be placed in the center.

The foregoing discussion illustrates uses and advantages of the invention. It will therefore be appreciated that there are various embodiments of the invention in which a foldable mechanical device is provided that aids contextual thinking, planning, problem solving and/or image viewing by allowing the selection of variables displayed around a central subject on parts that are deployable over the central subject.

In contrast with other tools that lead to sequential thinking or restricted accounting for variables, the Contextual Tool of the invention can encourage thinking holistically and contextually. It enables the user to view multiple aspects of a subject simultaneously. It can be constructed to be small and easily transportable.

Although the description above contains many specificities, these should not be construed as limiting the scope of the invention, but as merely providing illustrations of the presently preferred embodiments and uses of this invention.

What is claimed is:

1. A three-dimensional communication tool, said tool having a predetermined stowage configuration, said tool comprising:
a physical object having a plurality of predefined articulation joints and a predefined shaped periphery, said object including content sections, including a central content section and supporting content sections, said supporting content sections being at the periphery of said central content section, said supporting content sections having proximal portions associated with said central content section via said articulation joints, said supporting sections having distal portions, said distal portions cooperating to define said predefined shaped periphery, said surrounding content sections defining flaps which are foldable at said articulation joints toward said central content section, said flaps being deployed over at least a portion of said central content section when said object is in said predetermined stowage configuration and wherein said proximal portions define the periphery of said predetermined stowage configuration.

2. The tool of claim 1, wherein said physical object has a first side and a second side, at least one of said sides being separated into said content sections, wherein various of said content sections is capable of displaying content for communicating elements of a common theme.

3. The tool of claim 2, wherein said central content section includes fixed content and wherein said supporting content sections provide locations for application of user-content.

4. The tool of claim 2, wherein said central content section includes fixed content and wherein said supporting content sections provide locations for application of user-content, wherein said tool comprises a device for enabling contextual thinking, project planning and concept presentation, said device functioning according to said user content and said theme being guided by said fixed content, wherein the user-content may be user-generated, user-applied or user-selected, wherein the device functions according to the user content in cooperation with a theme guided by the fixed content.

5. The tool of claim 1, wherein said predetermined shape is polygonal.

6. The tool of claim 3 wherein said theme is a circle of caring planner for organization and planning of activities related to hospice issues.

7. The tool of claim 3, wherein said tool operates without electrical power.

8. The tool of claim 3, wherein said theme is a project decision-making facilitator for organization and planning of activities related to a project.

9. The tool of claim 5 wherein said theme is a school-minder for organization and planning of activities related to school.

10. The tool of claim 5 wherein said theme is organization and planning of activities related to life balance.

11. The tool of claim 5 wherein said fixed content includes images.

12. A contextual thinking tool and presentation device comprising:
a three dimensional physical object, said object having predefined fold lines, said object being foldable into a smaller object having a predetermined shape, said physical object having a plurality of predefined folding flaps associated with said fold lines and a predefined shaped periphery, said object including a central content section and supporting content sections, said supporting sections being defined on said flaps, said fold lines being at the periphery of said central section, said supporting sections having proximal portions associated with said central section via said fold lines, said supporting sections having distal portions, said distal portions cooperating to define said predefined shaped periphery, said flaps being foldable at said fold lines toward said central section and being deployable over at least a portion of said central section when said object is in said predetermined shape.

13. The tool of claim 12, wherein said physical object has a first side and a second side, said sides being separated into said sections, wherein each said section is capable of displaying content for communicating elements of a common theme.

14. The tool of claim 13, wherein said content includes fixed content and user-applied content.

15. The tool of claim 14, further comprising a device enabling contextual thinking, project planning and concept presentation, said device functioning according to said user-applied content and said theme being guided by said fixed content.

16. The tool of claim 14, wherein said tool operates without electrical power.

17. The tool of claim 14, wherein said tool is a foldable mechanical device that aids contextual thinking, planning, problem solving and image viewing by allowing the selection of 2-6 variables displayed around a central content.

18. The tool of claim 12 wherein said central section has N edges wherein N is greater than 2, and further comprising a flap that extends from at least two said edges, said flaps being of any selected shape, and wherein each flap is not larger than the central section.

19. The tool of clam 19 further comprising a plurality of said flaps and wherein said flaps are offset from said central section and form tabs when folded toward said center.

20. The tool of clam 19 further comprising a plurality of said flaps and wherein said flaps are offset from said central section and define a space for insertion of an item of interest.

21. The tool of claim 12 wherein said tool fits in a shirt pocket when in said predetermined stowage configuration.

22. three-dimensional communication tool, said tool having a predetermined stowage configuration, said tool comprising: a physical object having a plurality of predefined articulation joints and a predefined shaped periphery, said object including a central content section and supporting content sections, said supporting sections being at the periphery of said central section, said supporting sections having proximal portions associated with said central section via said articulation joints, said supporting sections having distal portions, said distal portions cooperating to define said predefined shaped periphery, and wherein said surrounding sections define flaps which are foldable at said articulation joints toward said central section.

23. The tool of claim 22, wherein said physical object has a first side and a second side, said sides being separated into said sections, wherein each said section is capable of displaying content for communicating elements of a common theme.
